(19) United States
(12) Patent Application Publication
(10) Pub. No.: US 2009/0162174 A1
(43) Pub. Date: Jun. 25, 2009

(54) Drum and container lifting apparatus

(76) Inventors: Michael Terrell, Waddell, AZ (US); David Viss, Waddell, AZ (US)

Correspondence Address: KLEIN, DENATALE, GOLDNER, COOPER et. al., P.O. BOX 11172, BAKERSFIELD, CA, 93389-1172, US

(21) Appl. No.: 12/313,032

(22) Filed: Nov. 13, 2008

Related U.S. Application Data
(60) Provisional application No. 61/003,013, filed on Nov. 13, 2007.

(51) Int. Cl. B60P 1/52; B60P 1/14

(52) U.S. Cl. 414/543; 414/547

(57) ABSTRACT

A receiver mounted drum lifter which may be mounted utilizing the receiver pocket of a standard tow bar trailer hitch. The receiver pocket is typically the female member of the hitch platform fitted to the vehicle, where the receive pocket normally receives a male member having a hitch ball attached. The disclosed device lifts a drum or similar container from a first position in which the long axis of the drum is oriented in a generally vertical position, with an inlet/outlet also oriented in an upright vertical position, to a second position in which the long axis of the drum is oriented such that the inlet/outlet is in a sufficiently downwardly facing position to allow the contents of the drum to be emptied through the inlet/outlet. Embodiments of the disclosed apparatus comprise a framework adapted to be mounted in the receiver pocket. The framework comprises a drum cradling section and an inertia overcoming section.

### CROSS-REFERENCE TO RELATED APPLICATION

U.S. Provisional Application No. 61/003,013 for this invention was filed on Nov. 13, 2007 for which these inventors claim domestic priority.

### BACKGROUND OF THE INVENTION

This invention generally relates to farm, construction and manufacturing equipment, and particularly to lifting devices which may utilized for lifting and dispensing the contents from a barrel, drum or other storage container, where the lifting device can quickly and removeably be installed on pick-up trucks, sport utility vehicles and the like.

Drums, barrels and other storage containers are often used in various industries, agriculture, and recreation for carrying liquids, such as water, fuel, oil, fertilizer, etc. These vessels are often heavy and difficult to maneuver, especially when full. For example, a fifty-five gallon drum containing water weighs approximately 500 pounds. Dispensing the contents of a drum from the back of a vehicle can be difficult and will often require either the use of a fork lift, crane, A-frame truck or some other device for lifting and inverting the drum. Alternatively, several persons might manually lift the drum into a position to empty the drum of its contents. Lifting a drum and dispensing liquids or other materials from the drum therefore typically requires the utilization of an expensive piece of equipment or sufficient manpower to lift the drum. Either solution has obvious drawbacks. A device is needed which is carried easily within a vehicle, is relatively inexpensive, may be removably attached to the vehicle, and may be operated by one or two persons for lifting and upending a storage drum.

### SUMMARY OF THE INVENTION

The present invention is directed to a receiver mounted drum lifter which meets the need identified above. Embodiments of the disclosed apparatus may be mounted by utilizing the receiver pocket of a standard tow bar trailer hitch which is commonly found on many vehicles. The receiver pocket is typically the female member of the hitch platform fitted to the vehicle, where the receive pocket normally receives a male member having a hitch ball attached.

Embodiment of the disclosed device lift a drum or similar container placed in the bed of a truck or similar vehicle from a first position in which the long axis of the drum is oriented in a generally vertical position, with an inlet/outlet also oriented in an upright vertical position, to a second position in which the long axis of the drum is oriented such that the inlet/outlet is in a sufficiently downwardly facing position to allow the contents of the drum to be emptied through the inlet/outlet.

Embodiments of the disclosed apparatus comprise a framework adapted to be mounted in the receiver pocket identified above. The framework comprises a drum cradling section and an inertia overcoming section.

### BRIEF DESCRIPTION OF THE DRAWINGS

FIG. 1 is a left perspective view of the receiver mounted drum lifter in the down position.

FIG. 2 is a close-up side view of the receiver mounted drum lifter in the down position.

FIG. 3 is left perspective view of the receiver mounted drum lifter in the lifted position

### DETAILED DESCRIPTION OF THE EMBODIMENTS

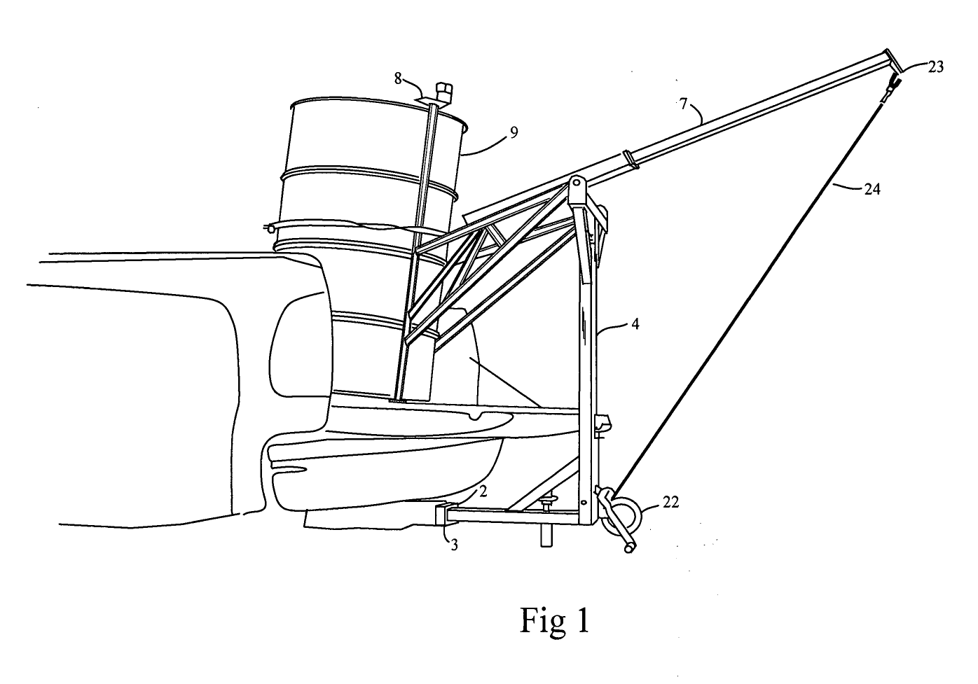

FIG. 1 shows a perspective view of an embodiment of the present drum lifter in the down position, viewed from the left side, shown is the coupling bar 1 constructed for insertion into the receiver pocket 2 of a tow bar trailer hitch 3.

There is a stationary frame member 4 that has a lower end and an upper end. The stationary frame member 4 lower end is attached to the coupling bar 1 and the stationary frame member 5 upper end has a horizontal member 5. The horizontal member 5 has a left side and a right side, and the left and right sides have an opposite pair of pivot points 6a and 6b. There is a movable frame member 7 that has a lower end and an upper end.

There is a cradle support frame comprising a left drum engagement member 8 that has first and second ends and a right drum engagement member 9 that has first and second ends. The left 8 and right 9 drum engagement members first ends have drum stop plates 11a and 11b to limit forward movement of the drum while the drum is being emptied, and it is within the device conceived that other movement limiters might be used.

There is a left upper support member 12 that has first and second ends, and a right upper support member 13 that has first and second ends. There is a left interior support member 14 that has first and second ends, and a right interior support member 15 that has first and second ends. There is a left lower support member 16 that has first and second ends and a right lower support member 17 that has first and second ends. The upper 12 and 13, interior 14 and 15, and lower 16 and 17 support members first ends are attached to the drum engagement members 8 and 9. The upper 12 and 13, and lower 16 and 17 support members second ends are attached to the horizontal member 5. The interior 14 and 15 support members second ends are attached to the upper end of the movable frame 7. There is a hand operable winch 22 attached to the lower end of the stationary frame member. There is a cable attachment point 23 attached to the lower end of the movable frame member, and a cable 24 extends from the winch to the cable attachment point. While the hand operated winch is shown in this embodiment it is to be appreciated that another type of winch or method of overcoming the inertia of the drum such as a pull-strap, pulley system or similar is contemplated.

It is to be appreciated that the dimensions are for a single embodiment and may vary according to other embodiments.

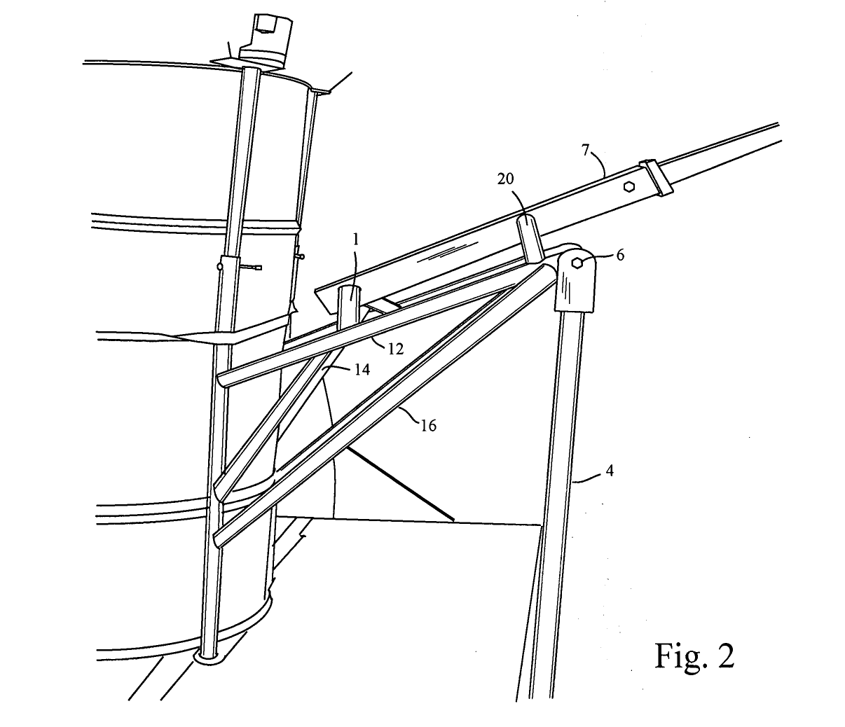

FIG. 2 shows a side view of an embodiment of the present drum lifter in the down position, in which the drum cradle assembly is shown in close-up. The horizontal member 5 attached to the upper end of the stationary frame member 4, as well as the pivot points 6a and 6b can be seen clearly in this Figure. The movable frame member 7 upper end can also be seen.

The left 8 and right 9 drum engagement members are shown. The drum support plate 10 engages the bottom of the drum, and has a left side and a right side and is connected to the respective left and right drum engagement members 8 and 9 second ends. The left 8 and right 9 drum engagement members first ends have drum stop plates 11a and 11b.

The left 12 and 13 right upper support members, the left 14 and right 15 interior support members, the left 16 and right 17 lower support members, the left 18 and right 19 proximal support members, and the left 20 and right 21 distal support members can also be seen. The upper 12 and 13, interior 14 and 15, and lower 16 and 17 support members first ends are attached to the drum engagement members 8 and 9. The upper 12 and 13, and lower 16 and 17 support members second ends are attached to the horizontal member 5. The interior 14 and 15 support members second ends are attached to the upper end of the movable frame 7. The distal 20 and 21, and proximal 18 and 19 support members first ends are attached to the upper 12 and 13 support members and the distal 20 and 21, and proximal 18 and 19 support members second ends are attached to the upper end of the movable frame 7.

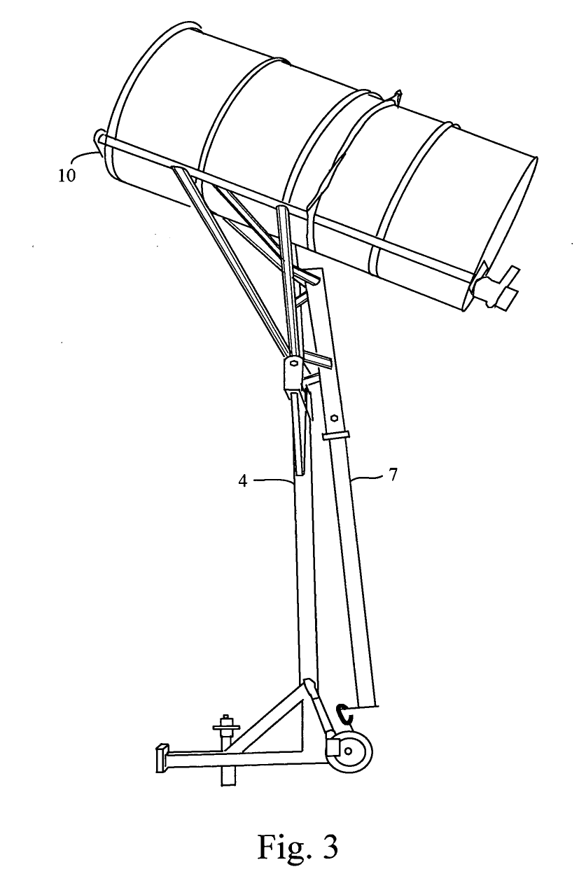

FIG. 3 shows the drum lifter in the up position, and with the cable entirely wound into the winch. There is a stationary frame member 4 that has a lower end and an upper end. The stationary frame member lower end is attached to the coupling bar and the stationary frame member upper end has a horizontal member 5. The horizontal member has a left side and a right side, and the left and right sides have an opposite pair of pivot points 6a and 6b. There is a movable frame member 7 that has a lower end and an upper end.

There is a cradle support frame comprising a left drum engagement member 8 that has first and second ends and a right drum engagement member 9 that has first and second ends. The left 8 and right 9 drum engagement members first ends have drum stop plates 11a and 11b, to limit forward movement of the drum while the drum is being emptied.

There is a left upper support member 12 that has first and second ends, and a right upper support member 13 that has first and second ends. There is a left interior support member 14 that has first and second ends, and a right interior support member 15 that has first and second ends. There is a left lower support member 16 that has first and second ends and a right lower support member 17 that has first and second ends. The upper 12 and 13, interior 14 and 15, and lower 16 and 17 support members first ends are attached to the drum engagement members 8 and 9. The upper 12 and 13, and lower 16 and 17 support members second ends are attached to the horizontal member 5. The interior 14 and 15 support members second ends are attached to the upper end of the movable frame 7. The hand operable winch 22, cable attachment point 23, and cable 24 can be seen.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. In a vehicle comprising a bed surface and a trailer hitch frame disposed near the bed surface, wherein a container may be disposed on the bed surface, the container comprising a top and a bottom, the top and the bottom defining a longitudinal axis, a lifting device for lifting the container above the bed surface and rotating the container from a first position in which the longitudinal axis is oriented in a generally vertical position to a second position in which the longitudinal axis is more than ninety degrees from the first position, the lifting device comprises:
an attachment member for removably attaching the lifting device to the trailer hitch frame;
a stationary frame member extending from the attachment member;
a moveable frame member rotatably attached to the stationary frame member, the moveable frame member comprising container attachment means; and
a mechanical advantage means connected to the moveable frame member, the mechanical advantage means assisting in the rotation of the container from the first position to the second position.

2. The lifting device of claim 1 wherein the mechanical advantage means comprises a winch-cable combination, wherein the winch is attached to the stationary frame member and an end of the cable is attached to the moveable frame member.

3. The lifting device of claim 1 wherein the container attachment means comprises a left container engagement member and a right container engagement member, wherein the left container engagement member and the right container engagement member are generally parallel to the longitudinal axis.

4. The lifting device of claim 3 wherein the upper ends of the left container engagement member and the right container engagement member comprise a container stop plate member.

5. The lifting device of claim 3 wherein the lower ends of the left container engagement member and the right container engagement member comprise a support plate.

6. The lifting device of claim 2 wherein the moveable frame member comprises the container attachment means at one end and a cable attachment member at the end opposite the container attachment means, the moveable frame member further comprising pivot pins disposed between the container attachment means and the cable attachment member.

7. The lifting device of claim 1 wherein the stationary frame member comprises a lower end and an upper end, wherein the attachment member is attached at the lower end and the upper end comprises a horizontal member.

8. The lifting device of claim 7 wherein the horizontal member comprises a left side and a right side, the left side and right side each comprising a pivot plate.

9. The lifting device of claim 6 wherein each pivot plate comprises an aperture.

10. In a vehicle comprising a bed surface and a trailer hitch frame disposed near the bed surface, wherein a container may be disposed on the bed surface, the container comprising a top and a bottom, the top and the bottom defining a longitudinal axis, a lifting device for lifting the container above the bed surface and rotating the container from a first position in which the longitudinal axis is oriented in a generally vertical position to a second position in which the longitudinal axis is more than ninety degrees from the first position, the lifting device comprises:
an attachment member for removably attaching the lifting device to the trailer hitch frame;
a stationary frame member extending from the attachment member, the stationary frame member comprises a lower end and an upper end, wherein the attachment member is attached at the lower end and the upper end comprises a horizontal member, the horizontal member comprising a right side plate and a left side plate, the right side plate and the left side plate each comprising an aperture;
a moveable frame member rotatably attached to the stationary frame member, wherein the moveable frame member comprises a container attachment means at one end and a cable attachment member at the end opposite the container attachment means, the moveable frame member further comprising an outwardly facing left side pivot pin disposed in the aperture of the left side plate and an outwardly facing right side pivot pin disposed in the aperture of the right side plate, the pivot pins disposed between the container attachment means and the cable attachment member; and
a winch attached to the stationary frame member, a cable from the winch attached to the cable attachment member.

11. The lifting device of claim 10 wherein the container attachment means comprises a left container engagement member and a right container engagement member, wherein the left container engagement member and the right container engagement member are generally parallel to the longitudinal axis.

12. The lifting device of claim 11 wherein the upper ends of the left container engagement member and the right container engagement member comprise a container stop plate member.

13. The lifting device of claim 12 wherein the lower ends of the left container engagement member and the right container engagement member comprise a support plate.
